(19) United States
(12) Patent Application Publication
(10) Pub. No.: US 2015/0146246 A1
(43) Pub. Date: May 28, 2015

(54) INFORMATION PROCESSING APPARATUS, SYSTEM, METHOD, AND STORAGE MEDIUM

(71) Applicant: CANON KABUSHIKI KAISHA, Tokyo (JP)

(72) Inventors: Naoki Ito, Tokyo (JP); Koya Shimamura, Kawasaki-shi (JP)

(21) Appl. No.: 14/526,572

(22) Filed: Oct. 29, 2014

(30) Foreign Application Priority Data
Nov. 22, 2013 (JP) 2013-242160

(51) Int. Cl. H04N 1/32; H04N 1/387; H04N 1/00

(52) U.S. Cl. CPC H04N 1/32144; H04N 1/00251; H04N 1/00233; H04N 1/00244; H04N 1/387; H04N 2201/0094; H04N 2201/0081
USPC 358/1.15

(57) ABSTRACT

There is provided an information processing apparatus capable of communicating with an apparatus capable of supplying image data via a network, and for providing a cloud-type printing service. The information processing apparatus includes: a unit configured to determine whether a mark indicating that an image can be added is included in a print image; a unit configured to prompt the apparatus capable of supplying image data to supply data of an additional image in the case where it is determined that the mark is included in the print image; a combination unit configured to combine the additional image supplied from the apparatus with the print image; and a unit configured to give instructions to print the combined image generated by the combination to a printing apparatus connected via the network.

### BACKGROUND OF THE INVENTION

1. Field of the Invention

The present invention relates to an information processing apparatus, a system, a method, and a program.

2. Description of the Related Art

Conventionally, there exists a workflow for performing a variety of applications using a paper application form. Normally, the format of an application form is fixed and application processing is performed by filling in the necessary items in a printed application form by handwriting etc. in accordance with the format. In addition to filling in by handwriting, there is a case where printed matter (photo) of a photographed image is affixed to the application form with a paste etc.

In recent years, electronizing a paper application form by using a scan function of an MFP (Multi Function Peripheral), a document scanner, or the like, and processing application task as an electronic workflow are performed.

In such circumstances, a mobile terminal, such as a smart phone and a tablet terminal, has begun to be provided with a camera, and at present, it has been made possible to easily perform photographing at any time.

Then, in a system in which an application task is processed as an electronic workflow as described previously, attaching an image photographed by a mobile terminal directly to an image of an electronized application form is also considered. Regarding this, there exists a technique for replacing part of an image read by a scan with a specific image (e.g., Japanese Patent Laid-Open No. 2001-292300). Performing processing to replace part of an image of an application form obtained by a scan in advance with an image photographed in advance by making use of the technique such as this is also considered.

However, in the case where the technique described in Patent Document 1 is adopted, it is necessary to prepare data of an image for replacement by photographing the image in advance. Besides that, it is necessary to separately construct a new system of a workflow that is different from the workflow based on paper that handles an application form to which a printed photo is affixed physically.

Then, the case where it is desired to add image data obtained separately by photographing etc. to image data, such as an electronized document, is also supposed other than the above-described application task.

### SUMMARY OF THE INVENTION

An information processing apparatus according to the present invention is an information processing apparatus capable of communicating with an apparatus capable of supplying image data via a network, and for providing a cloud-type printing service, and includes a unit configured to determine whether a mark indicating that an image can be added is included in a print image; a unit configured to prompt the apparatus capable of supplying image data to supply data of an additional image to be added in the case where it is determined that the mark is included in the print image; a combination unit configured to combine the additional image supplied from the apparatus with the print image; and a unit configured to give instructions to print the combined image generated by the combination to a printing apparatus connected via the network.

According to the present invention, it is possible to easily add and combine an image without the need to prepare an image to be added in advance in a scene in which an image is added to print data or data saved in a storage that is used in cloud services.

Further features of the present invention will become apparent from the following description of exemplary embodiments (with reference to the attached drawings.)

### BRIEF DESCRIPTION OF THE DRAWINGS

FIG. 1 is a diagram showing an example of a configuration of a system for providing cloud-type services;

FIG. 2 is a block diagram showing an example of a hardware configuration of an MFP;

FIG. 3 is a block diagram showing an example of a hardware configuration of a cloud service server;

FIG. 4 is a block diagram showing an example of a hardware configuration of a mobile terminal;

FIG. 5 is a diagram showing an example of a software configuration that the MFP includes according to a first embodiment;

FIG. 6 is a block diagram showing an example of a software configuration that the mobile terminal includes according to the first embodiment;

FIG. 7 is a diagram showing an example of a software configuration that the cloud service server includes according to the first embodiment;

FIG. 8 is a diagram showing an example of a software configuration that a cloud storage server includes according to the first embodiment;

FIG. 9 is a sequence chart showing a flow of processing from uploading processing of print image data until printing is completed according to the first embodiment;

FIG. 10 is a diagram showing an example of a UI screen in the case where the mobile terminal gives instructions to perform printing;

FIG. 11 is a diagram showing the relationship between FIGS. 11A and 11B;

FIGS. 11A and 11B are diagrams showing an example of HTML data of an image addition page;

FIG. 12 is a diagram showing a UI screen of the “image addition page”;

FIG. 13 is a flowchart showing a flow of processing in the cloud service server according to the first embodiment;

FIG. 14 is a flowchart showing details of the uploading processing of print image data;

FIG. 15 is a flowchart showing details of processing to print the print image data kept in the cloud storage server;

FIG. 16 is a diagram showing an example of a UI screen for specifying a direction in which an image is pasted;

FIG. 17 is a diagram showing an example of a hardware configuration that an MFP includes according to a second embodiment;

FIG. 18 is a diagram showing an example of a software configuration that a cloud service server includes according to the second embodiment;

FIG. 19 is a sequence chart showing a flow of processing from scan processing of a paper document until scan data as saving-target image data is saved in a storage server according to the second embodiment;

FIG. 20 is a flowchart showing a flow of processing in the cloud service server according to the second embodiment;

FIG. 21 is a flowchart showing details of the uploading processing of saving-target image data; and

FIG. 22 is a flowchart showing details of processing to save the saving-target image data in a cloud storage server.

### DESCRIPTION OF THE EMBODIMENTS

Hereinafter, embodiments for embodying the present invention are explained by using the drawings.

### First Embodiment

In the present embodiment, an image processing system is explained in which instructions to perform printing of print image data placed in a server are given by a mobile terminal etc. and at the same time, it is possible to perform printing after adding image data of a photo photographed etc. by the camera application of the mobile terminal to the print image data.

### <System Configuration>

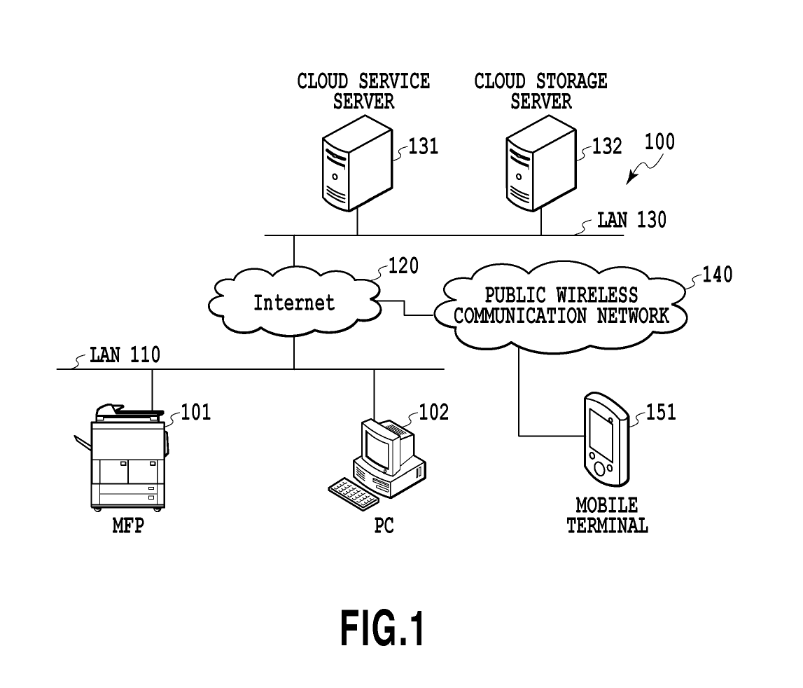

FIG. 1 is a diagram showing an example of a configuration of a system that provides cloud-type services.

In a system 100 shown in FIG. 1, an MFP 101 and a PC 102 are connected to a LAN 110, such as Ethernet (registered trademark) and a wireless LAN. Further, a cloud service server 131 and a cloud storage server 132 are connected to a LAN 130, such as Ethernet and a wireless LAN. Furthermore, a mobile terminal 151 is connected to a public wireless communication network 140. Then, the LAN 110, the LAN 130, and the public wireless communication network 140 are connected to an Internet network 120. Due to this, each device connected to each network can communicate with one another and it is made possible for the MFP 101, the PC 102, and the mobile terminal 151 to supply image data to the cloud service server 131.

In FIG. 1, the cloud service server 131 and the cloud storage server 132 are connected onto the same LAN 130, but they may be connected onto different LANs. Further, the cloud service server 131 and the cloud storage server 132 may be implemented by a virtual server constructed on the cloud.

The MFP 101 is a multi function peripheral having a printer function and a scanner function. In the present image processing system 100, the MFP 101 is made use of as a print terminal and a scan terminal of a paper document.

The cloud service server 131 is a server for providing cloud services via a network. In the case of the present embodiment, the cloud service server 131 is a server that provides a service to receive image data together with instructions to perform printing from the PC 102, perform processing to convert the image data into data in the printable state, and transmit the image data after the conversion processing to the cloud storage server 132. As an example of the above-described processing to convert data into data in the printable state, mention is made of processing to convert image data into bitmap data and processing to convert data into PDL (Page Description Language) data that an image forming apparatus can interpret.

The cloud storage server 132 is a server for saving data.

The mobile terminal 151 is a device capable of accessing uploaded image data in order to receive a service provided by the cloud service server 131 and an relevant example is a so-called smart phone. In the present embodiment, it is assumed that communication between the mobile terminal 151 and the cloud service server 131 is performed by a Web browser as a client application. It is also assumed that various kinds of operations that can be performed in the mobile terminal 151 can also be performed in the PC 102.

### <Hardware Configuration of MFP>

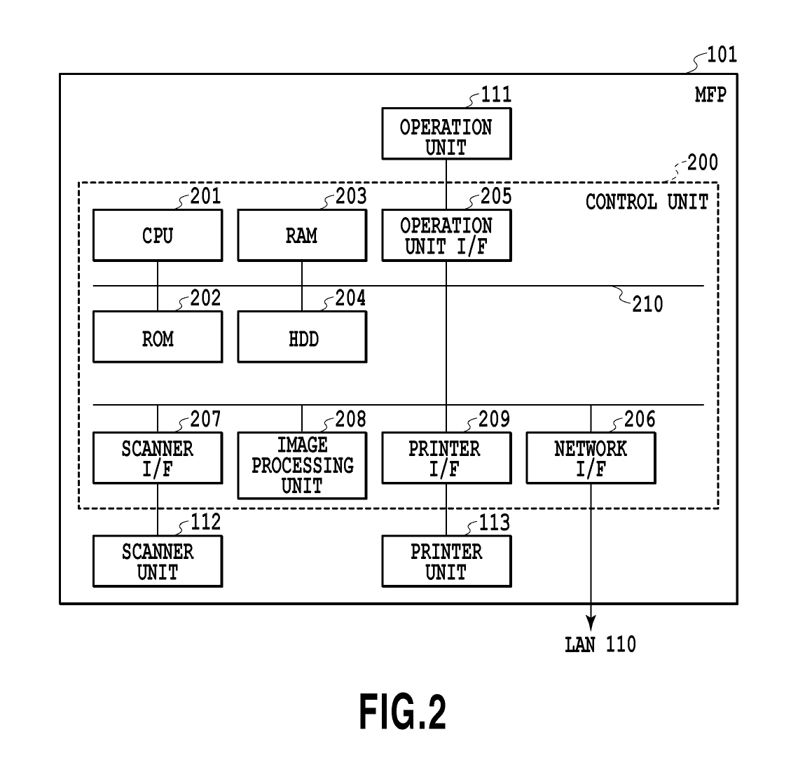

FIG. 2 is a block diagram showing an example of a hardware configuration of the MFP 101 and the hardware configuration includes an operation unit 111, a scanner unit 112, a printer unit 113, and a control unit 200.

The operation unit 111 includes a liquid crystal panel having a touch screen function and has functions to display various kinds of information to a user and to receive a user input, such as scan instructions.

The scanner unit 112 has a function to scan a document (in the present embodiment, an application form of estate) set on a document table or an ADF to acquire image data.

The printer unit 113 has a function to print an image on a printing medium, such paper, by using image data received from the control unit 200.

The control unit 200 is electrically connected with each unit described above and at the same time, is connected to the LAN 110. The control unit 200 includes a CPU 201, a ROM 202, a RAM 203, an HDD 204, an operation unit I/F 205, a network I/F 206, a scanner I/F 207, an image processing unit 208, a printer I/F 209, and an internal bus 210.

The CPU 201 is a processor that comprehensively controls the MFP 101 and controls each unit connected via the internal bus 210 based on control programs etc. stored in the ROM 202.

The RAM 203 is a system work memory for the CPU 201 to operate, and also a memory for temporarily storing image data.

The HDD 204 is a hard disk drive and stores system software and image data.

The operation unit I/F 205 is an interface that connects the internal bus 210 and the operation unit 111 and outputs data of an image to be displayed on the operation unit 111 to the operation unit 111 and delivers an input, such as instructions of a user input through the operation unit 111.

The network I/F 206 is an interface that connects the internal bus 210 and the LAN 110 and transmits and receives various kinds of information, such as image data, to and from other devices (e.g., the cloud service server 131) connected via the LAN 110.

The scanner I/F 207 is an interface that connects the internal bus 210 and the scanner unit 112 and also performs correction, processing, edition, etc., of scan data received from the scanner unit 112.

The image processing unit 208 performs various kinds of image processing, such as rotation, compression, and decompression of an image.

The printer I/F 209 receives image data from the image processing unit 208 and generates image data for printing while referring to attribute information accompanying the image data. The image data for printing is sent to the printer unit 113 and printed and output.

### <Hardware Configuration of Cloud Service Server>

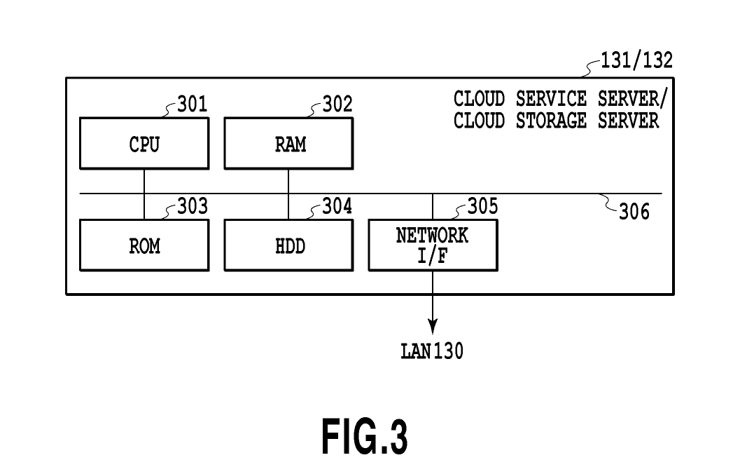

FIG. 3 is a block diagram showing an example of a hardware configuration of the cloud service server 131 as an information processing apparatus.

The cloud service server 131 includes a CPU 301, a RAM 302, a ROM 303, an HDD 304, a network I/F 305, and an internal bus 306.

In the ROM 303 or the HDD 304, control programs, such as an operating system and applications, are stored. The CPU 301 exhibits the functions as a computer by reading the control programs onto the RAM 302 from the ROM 303 or the HDD 304 in accordance with necessity and by executing the control programs.

The network I/F 305 is an interface that connects the internal bus 306 and the LAN 130 and transmits and receives various kinds of information, such as image data, to and from other devices connected via the LAN 130.

The configurations of the cloud storage server 132 and the CPU 102 are the same as the configuration of the cloud service server 131 explained in FIG. 3.

### <Hardware Configuration of Mobile Terminal>

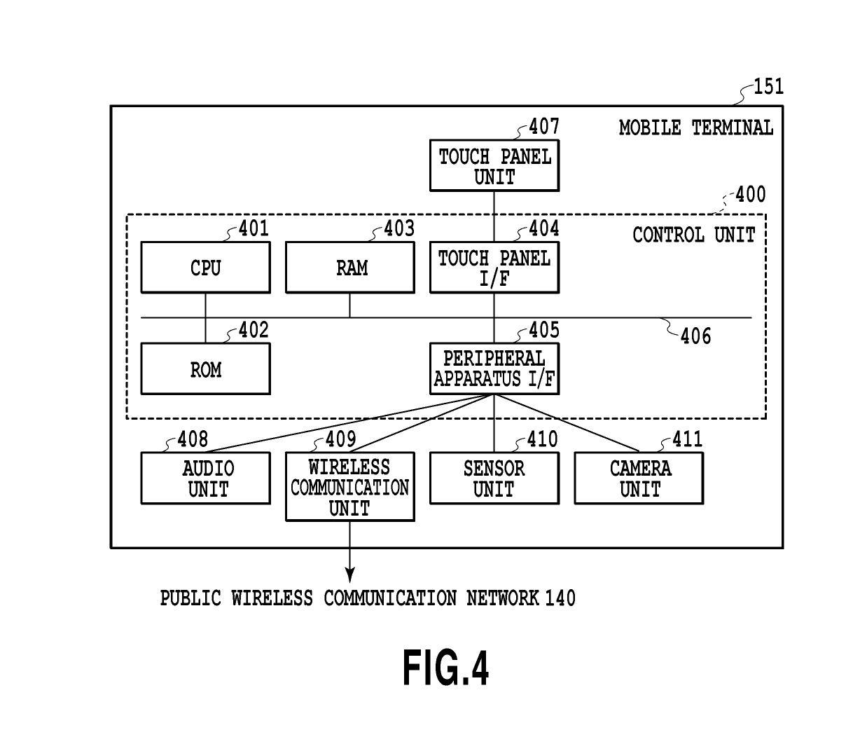

FIG. 4 is a block diagram showing an example of a hardware configuration of the mobile terminal 151.

The mobile terminal 151 includes a control unit 400, a touch panel unit 407, an audio unit 408, a communication unit 409, a sensor unit 410, and a camera unit 411.

The control unit 400 includes a CPU 401, a ROM 402, a RAM 403, a touch panel I/F 404, a peripheral device I/F 405, and an internal bus 406.

The CPU 401 comprehensively controls each unit based on control programs etc. stored in the ROM 402. Further, the CPU 401 controls the audio unit 408, the communication unit 409, the sensor unit 410, and the camera unit 411 via the peripheral device I/F 405.

The RAM 403 is made use of as a work area at the time of the execution of a program.

The touch panel I/F 404 is an interface that connects the internal bus 406 and the touch panel unit 407 and is capable of simultaneously performing processing on data related to the pressure and position of the touch operation to the touch panel unit 407 for a plurality of touched points. Further, the touch panel unit 407 receives the input operation of a user and at the same time, displays various kinds of information to a user.

The audio unit 408 includes a speaker that outputs a sound and a volume adjusting device.

The wireless communication unit 409 performs transmission and reception of various kinds of information, such as image data, with other devices connected via the public wireless communication 140 by wireless communication.

The sensor unit 410 includes various kinds of sensors for measuring inclination, acceleration, brightness, etc.

The camera unit 411 includes a lens, an image capturing element, etc., for performing photographing.

### <Software Configuration of MFP>

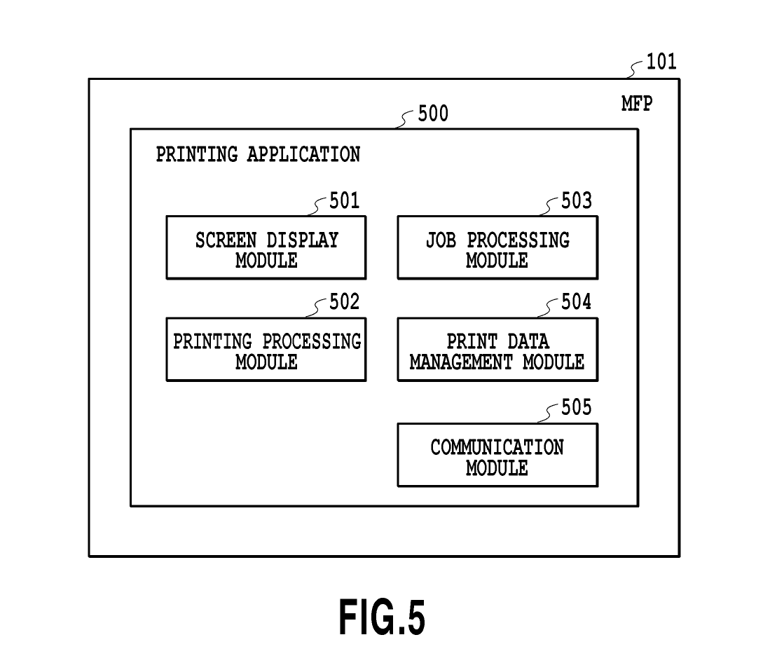

FIG. 5 is a diagram showing an example of a software (printing application and its modules for printing processing) configuration that the MFP 101 includes. The program of the printing application is stored in the HDD 204 and the CPU 201 develops the program onto the RAM 203 and then executes the program.

A printing application 500 is software for receiving image data related to printing instructions given to the cloud service server 131 and includes each of modules 501 to 505 below.

A screen display module 501 is a software module for displaying that printing processing is being performed on the operation unit 111.

A printing processing module 502 is a software module for storing image data received via the network I/F 206 in the HDD 204 and for forming an image in accordance with the image data on a printing medium by driving the printer unit 113 via a printer I/F 216. A job processing module 503 is a software module for converting image data stored in the HDD 204 into an image format, such as JPEG.

A print data management module 504 is a software module for managing image data converted in the job processing module 503 as print image data.

A communication module 505 is a software module for performing communication with the cloud service server 131 via the network I/F 206.

### <Software Configuration of Mobile Terminal 151>

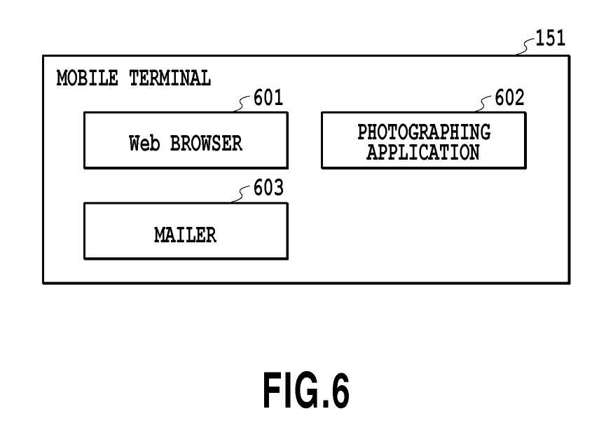

FIG. 6 is a block diagram showing an example of a software (Web browser, photographing application, mailer) configuration that the mobile terminal 151 includes. The programs of these applications are stored in the ROM 402 of the mobile terminal 151 and the CPU 401 develops the programs onto the RAM 403 and executes the programs.

A web browser 601 performs communication by a predetermined protocol, such as HTTP, with the cloud service server 131 and displays HTML data sent from the cloud service server 131 and receives an input from a user.

A photographing application 602 causes the camera unit 411 to perform photographing in accordance with the operation instructions from a user. Data of a photographed image is stored in the ROM 402.

A mailer 603 communicates with an electronic mail server (not shown) connected via the public wireless communication network 140 and transmits and receives electronic mails.

### <Software Configuration of Cloud Service Server 131>

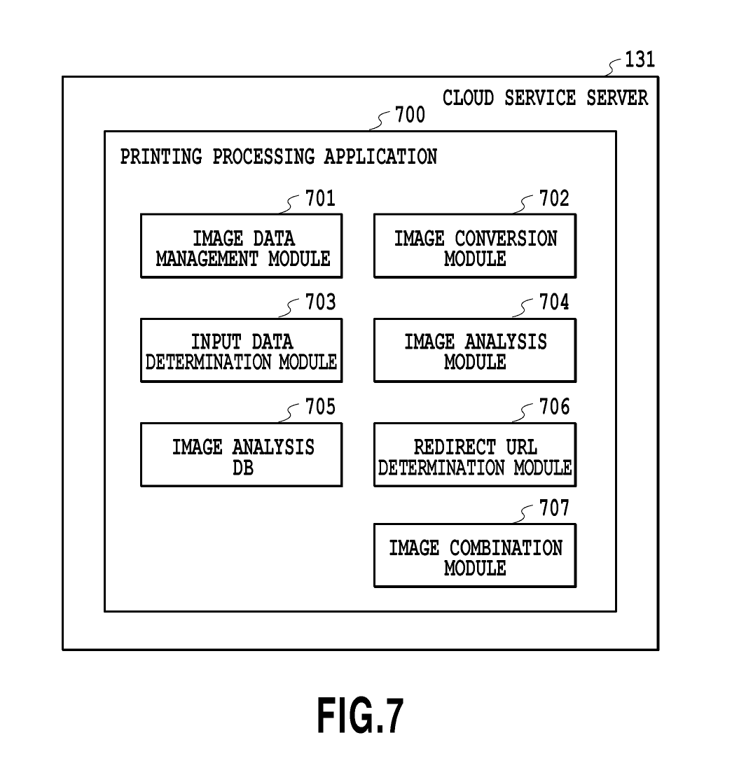

FIG. 7 is a diagram showing an example of a software (printing processing application and its modules) configuration that the cloud service server 131 includes. The program of the application is stored in the HDD 304 and the CPU 310 develops the program onto the RAM 302 and then executes the program.

A printing processing application 700 is a Web application for making public Web services on the cloud service server 131 and for performing processing etc. to convert print image data sent via the Internet network 120 into image data that an image forming apparatus can make use of.

An image data management module 701 is a module for managing intermediate data produced in the processes of various kinds of processing on print image data within the cloud service server 131 and the results of the above-described conversion processing (raster image data).

An image conversion module 702 is a module for performing processing to convert print image data received by the printing processing application 700 into data in the printable state, specifically, for turning PDL data into a raster image by conversion.

An input data determination module 703 is a module for determining the kind of print image data received by the printing processing application 700. In the present embodiment, the input data determination module 703 determines whether the print image data transmitted from the PC 102 is image data in the bitmap format, such as JPEG, or image data described in the PDL.

An image analysis module 704 is a module for checking whether a mark indicating that an image can be added is included in the print image data received by the printing processing application 700 and for performing analysis (decode) processing thereon in the case where the mark is included. As check processing, for example, whether a mark that agrees with a mark registered in advance in an image analysis DB 705 exists within the received print image data is checked by comparison. Further, in the case where the above-described mark is, for example, a QR code (registered trademark), it may also be possible to perform processing to recognize a two-dimensional code (so-called finder pattern search processing), such as a QR code, included in the image data, as the above-described check processing. In the case where the above-described mark exists in the received print image data, an image photographed by the camera of the mobile terminal 151 is enabled to be inserted into the print image. It may also be possible to insert an image stored in an SD card memory etc. that can be attached to the interior of the mobile terminal 151 in place of an image photographed by the camera of the mobile terminal 151.

A redirect URL determination module 706 is a module for determining a redirect URL at the time of the reception of a request to print the uploaded print image data.

An image combination module 707 performs processing to combine data of an additional image photographed etc. by the mobile terminal 151 etc. with the print image data.

### <Software Configuration of Cloud Storage Server 132>

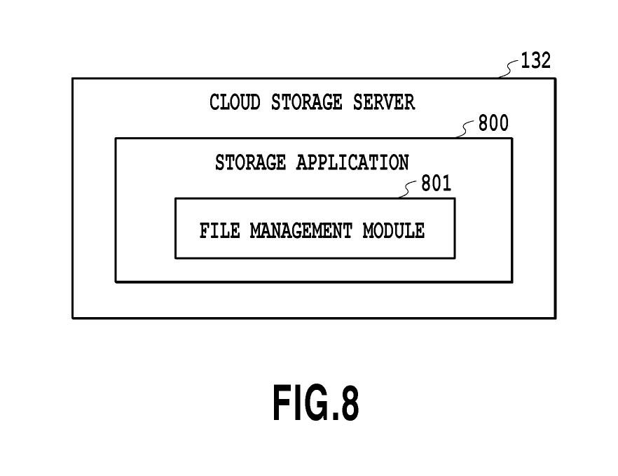

FIG. 8 is a diagram showing an example of a software (storage application and its modules) configuration that the cloud storage server 132 includes. The program of the application is stored in the HDD 304 and the CPU 310 develops the program onto the RAM 302 and then executes the program.

A storage application 800 is a Web application for making public the Web services on the cloud storage server 132 and for managing electronic files, such as image data, sent via the Internet network 120.

A file management module 801 is a module for receiving an electronic file in accordance with instructions from the storage application 100 and for saving and managing the electronic file in the HDD 304 via middleware, such as a file system or a DB.

### <Processing Sequence>

Next, a flow of the processing from uploading processing of print image data to be printed until printing is completed according to the present embodiment is explained. Here, a case is premised where a group that shares the cloud-type printing service is registered in advance and in the case where someone in the group uploads image data, a notification is made to the mobile terminals etc. of all the members in the group and a member in the group prints the uploaded image data. Before detailed explanation is given, an outline is explained as follows.

First, image data to be printed is uploaded to the system 100 from the PC 102. Then, in the case where the mobile terminal 151 etc. having received the notification of uploading accesses the system 100, on a condition that there is a mark indicating that an image can be added to the uploaded print image, the camera application of the mobile terminal 151 or the storage folder of the photo image is displayed on the screen. In the case where a user uploads an image photographed by the camera application or an image stored within the folder (hereinafter, an additional image), the additional image is inserted into the image data to be printed and then is printed.

In the present embodiment, a case is explained as an example, where the PC 102 gives instructions to upload print image data and the mobile terminal 151 gives instructions to print the print image data, but it may also be possible for one and the same device to give, for example, instructions to perform uploading and instructions to perform printing at the same time.

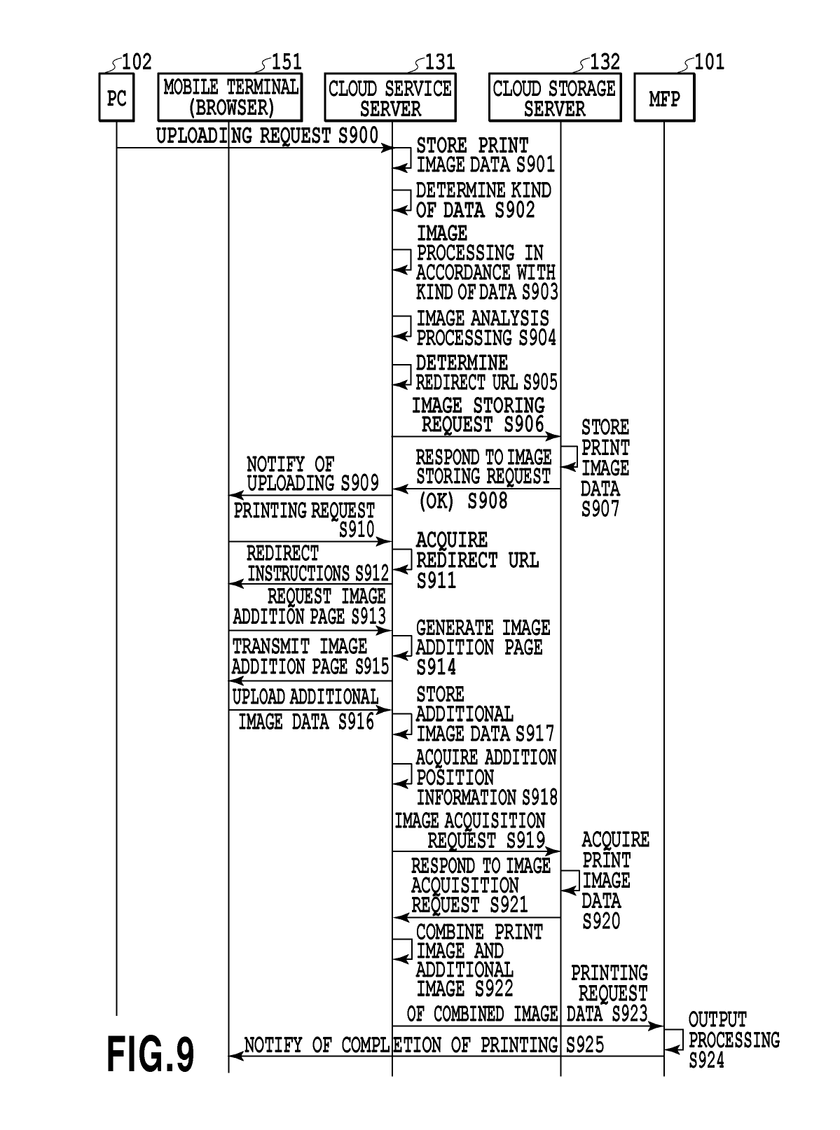

FIG. 9 is a sequence chart showing a flow of the processing from uploading processing of print image data until printing is completed. Hereinafter, detailed explanation is given.

At step 900, upon receipt of the instructions of a user, the PC 102 makes a request to upload print image data to the cloud service server 131. In the uploading request, information on a user who has given the instructions and image data to be printed are included.

At step 901, the cloud service server 131 stores received print image data in the HDD 304.

At step 902, the cloud service server 131 (input data determination module 703) determines the kind of the received print image data.

At step 903, the cloud service server 131 (image conversion module 702) performs image processing (conversion into raster data etc.) in accordance with the kind of the received print image data based on the determination result at step 902.

At step 904, the cloud service server 131 (image analysis module 704) performs the previously-described analysis processing on the image data converted into data in the printable state.

In the case where a mark indicating that an image can be added is recognized as the result of the analysis processing at step 904, the cloud service server 131 (redirect URL determination module 706) determines the redirect URL at step 905. The redirect URL in this case will be a URL to activate a camera application or a URL to activate an application that makes it possible to access an image file within the mobile terminal 15.

At step 906, the cloud service server 131 transmits the uploaded print image data to the cloud storage server 132 and makes a request to store the print image data.

At step 907, the cloud storage server 132 stores and manage the print image data received from the cloud service server 131.

At step 908, the cloud storage server 132 returns a response to the effect that storage of the print image data has been completed to the cloud service server 131.

At step 909, the cloud service server 131 makes a notification to the effect that print image data has been uploaded by a member within the group by referring to mail addresses registered in advance. This notification includes information, such as an ID (e.g., a1234) and a file name of the uploaded print image data. Here, it is assumed that the address of the mobile terminal 151 is registered as a notification destination. In this case, to the PC 102 having made the uploading request also, a response, for example, such as “HTTP/1.1 200 OK/a1234”, is transmitted.

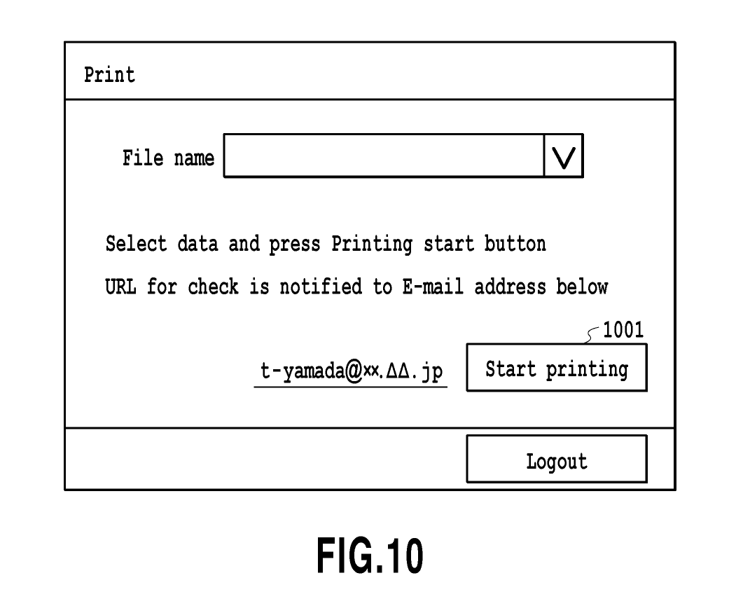

At step 910, upon receipt of instructions of a user, the mobile terminal 151 transmits a request to print the print image data related to the notification to the cloud service server 131. FIG. 10 is a diagram showing an example of a UI screen at the time of giving printing instructions from the mobile terminal 151. In the case where the image data desired to be printed is specified and a Print start button 1001 is pressed down, the printing request is transmitted to the cloud service server 131. At this time, in the printing request, a date, a job ID, etc., are included in addition to the ID of the target print image data (a1234 described above).

At step 911, upon receipt of the printing request from the mobile terminal 151, the cloud service server 131 acquires the redirect URL determined at step 905.

At step 912, the cloud service server 131 instructs the mobile terminal 151 to redirect to “image addition page” based on the acquired redirect URL. Here, the “image addition page” is a UI screen on which to specify an image to be added to the print image data. By the UI screen such as this, a user is prompted to add an image.

At step 913, the mobile terminal 151 makes a request for the “image addition page” to the cloud service server 131 (GET request) based on the redirect instructions.

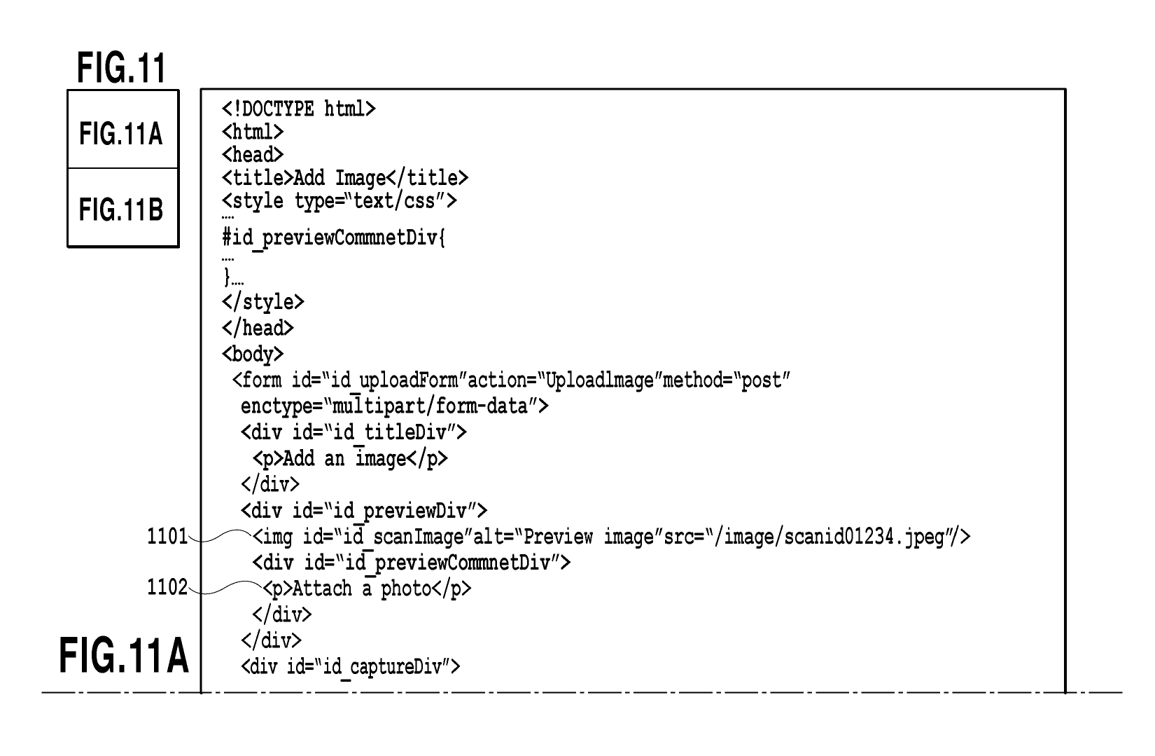

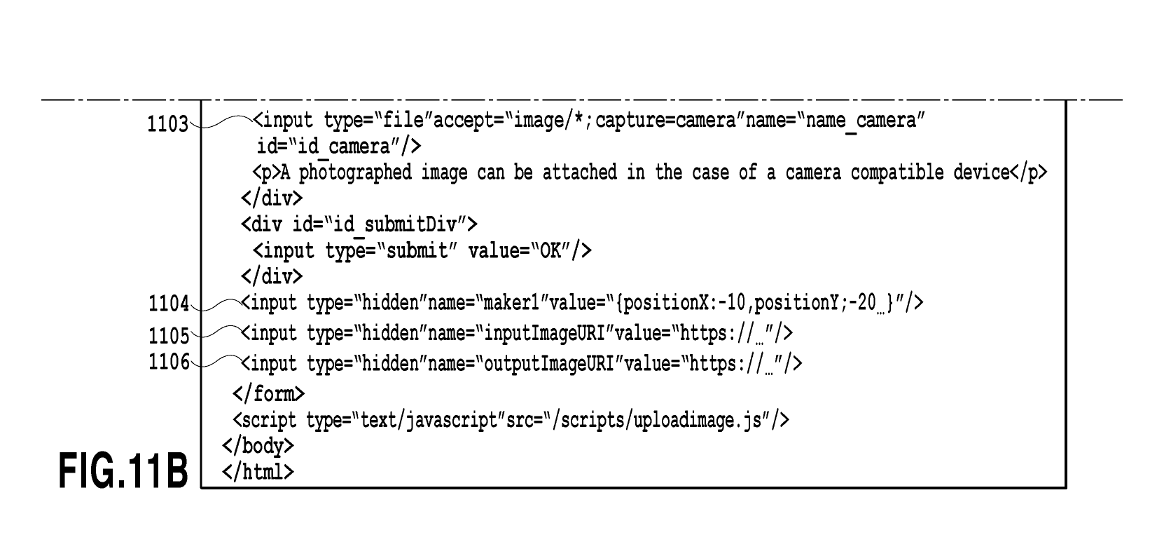

At step 914, the cloud service server 131 generates HTML data of the image addition page. FIGS. 11A and 11B are diagrams showing an example of HTML data of the image addition page. However, part of the style sheet and script portions are omitted.

An element 1101 is a portion indicating a preview image to be displayed on the Web browser.

An element 1102 is a portion for specifying a character string to be displayed on the screen of the image addition page, and here, a character string of “Attach a photo” is specified.

An element 1103 is a portion indicating that an image to be attached to an electronic document is selected by activating a camera to perform photographing. In the case where a mobile terminal having the camera function is compatible with the Web browser, it is possible to activate the camera and to photograph a photo of estate to be attached on the spot. Further, it is also possible to select a photo from among an image file photographed and prepared in advance.

Elements 1104 to 1106 are hidden input elements and are made use of to deliver information to the printing processing application 700 again in the case where a display is produced within a script or where a Web page is submitted.

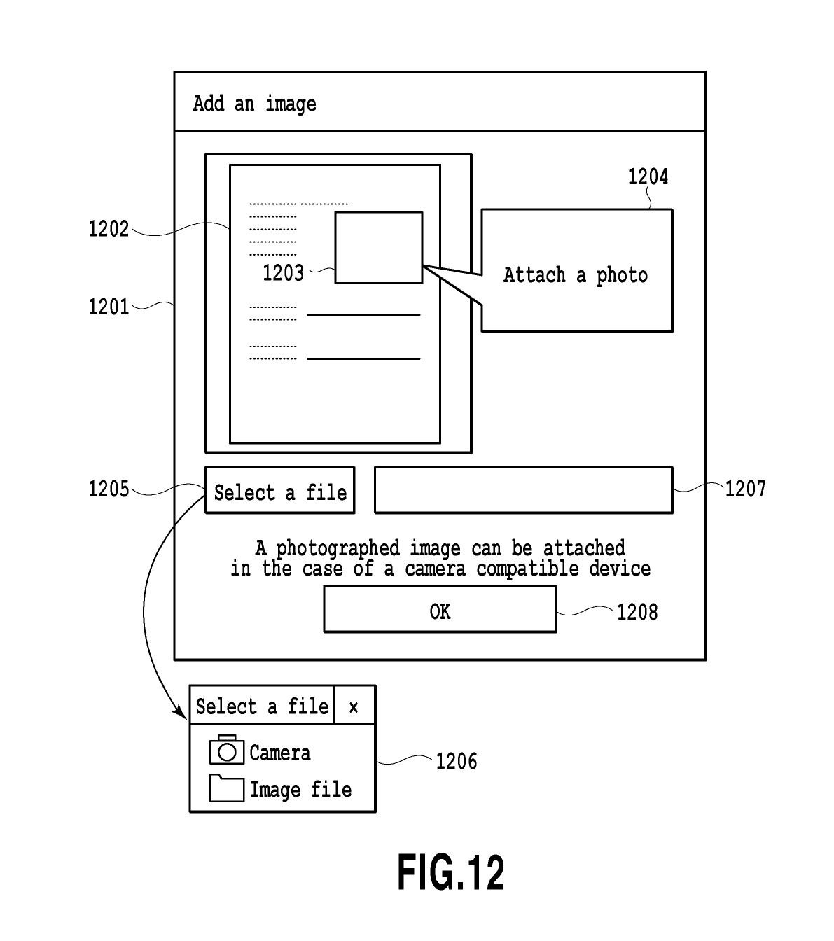

At step 915, the cloud service server 131 transmits the data of the generated UI screen (HTML data) to the mobile terminal 151. The mobile terminal 151 performs rendering of the received HTML data and displays the “image addition page”. FIG. 12 shows a UI screen of the “image addition page” corresponding to the HTML data in FIGS. 11A and 11B.

An area 1201 is a preview area and a preview image 1202 indicated by an element 1202 is displayed.

An area 1203 indicates an insertion position of an additional image in the preview image 1202. Then, by a balloon for the area 1203, a message 1204 is displayed. The contents of the message in the balloon correspond to the character string specified by the previously-described element 1102.

A button 1205 is a button for specifying an image to be added and a sub screen 1206 is displayed by pressing down the button and on the sub screen 1206, it is possible for a user to specify to perform photographing with an attached camera or to select an image from an already-existing image file. For example, in the case where “Camera” is specified, the photographing application activates and the state where photographing is possible is brought about and after a user ends photographing, the path of the photographed image is returned to the browser and is displayed within an area 1207. It may also be possible to select “Image file” and to specify desired image data from an SD memory card etc. that can be attached to the mobile terminal 151. In this case, the path of the specified image data is displayed within the area 1207 as a result.

An OK button 1208 is a button for uploading data of a photographed (or selected) image (for submitting the “image addition page”).

Explanation is returned to the flowchart in FIG. 9.

At step 916, the mobile terminal 151 transmits data of an image photographed etc. by a user to the cloud service server 131 as additional image data.

At step 917, the cloud service server 131 stores the additional image data received from the mobile terminal 151 in the HDD 304.

At step 918, the cloud service server 131 acquires information for specifying an insertion position of the additional image (hereinafter, addition position information) obtained by the analysis processing at step 904. The addition position information includes, for example, contents indicating that an image photographed etc. is inserted into one portion on the third page of the print image data including five pages in total. Further, it is also possible to, for example, insert an additional image itself as one page.

At step 919, the cloud service server 131 transmits a request to acquire the print image data stored at step 907 to the cloud storage server 132.

At step 920, the cloud storage server 132 acquires print image data related to the acquisition request from the stored image data.

At step 921, the cloud storage server 132 responds to the acquisition request and transmits the print image data related to the acquisition request to the cloud service server 131.

At step 922, the cloud service server 131 (image combination module 707) combines the print image data and the additional image data in accordance with the previously-described addition position information.

At step 923, the cloud service server 131 transmits the combined image data generated by the combination processing to the MFP 101.

At step 924, the MFP 101 performs processing to produce a printout of the received combined image data.

At step 925, the MFP 101 transmits a notification to the effect that printing has been completed to the mobile terminal 151.

The above is the flow of the processing from the uploading processing until printing is completed.

In the case where a mark indicating that an image can be added is not recognized by the result of the analysis processing at step 904, upon receipt of the printing request (step 910), the request to acquire an image is made immediately (step 919), and instructions to print the image are given to the MFP 101 (step 923). Then, the MFP 101 performs processing to print the print image data on which is nothing has been performed after the print image data is uploaded (step 924).

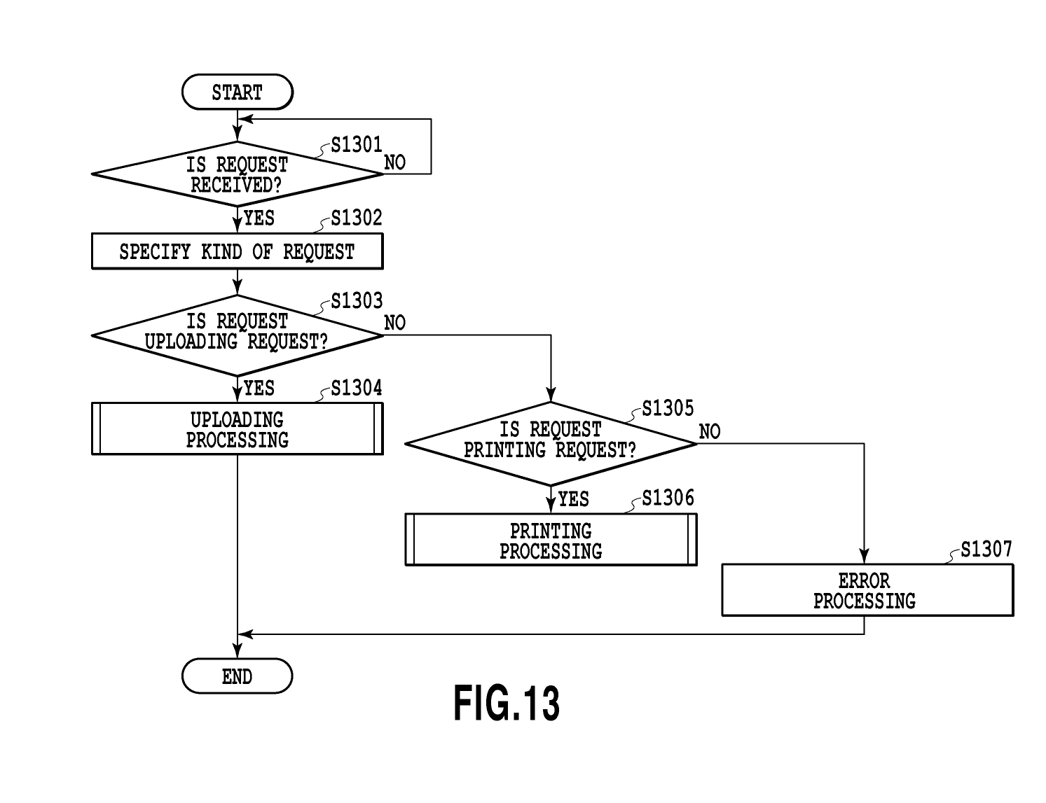

Next, by focusing on the processing performed in the cloud service server 131, a flow of each piece of processing is explained. FIG. 13 is a flowchart showing a flow of the processing in the cloud service server 131.

At step 1301, the printing processing application 700 is in the state of waiting for a request as a Web application. Upon receipt of a request, the processing proceeds to step 1302.

At step 1302, the printing processing application 700 acquires request URL information included in the received request and specifies the kind of the request. In the present embodiment, there are two kinds of requests, an uploading request and a printing request.

At step 1303, the printing processing application 700 determines whether or not the kind of request specified at step 1302 is an uploading request. In the case where the kind of request is an uploading request, the processing proceeds to step 1304. On the other hand, in the case where the kind of request is not an uploading request, the processing proceeds to step 1305.

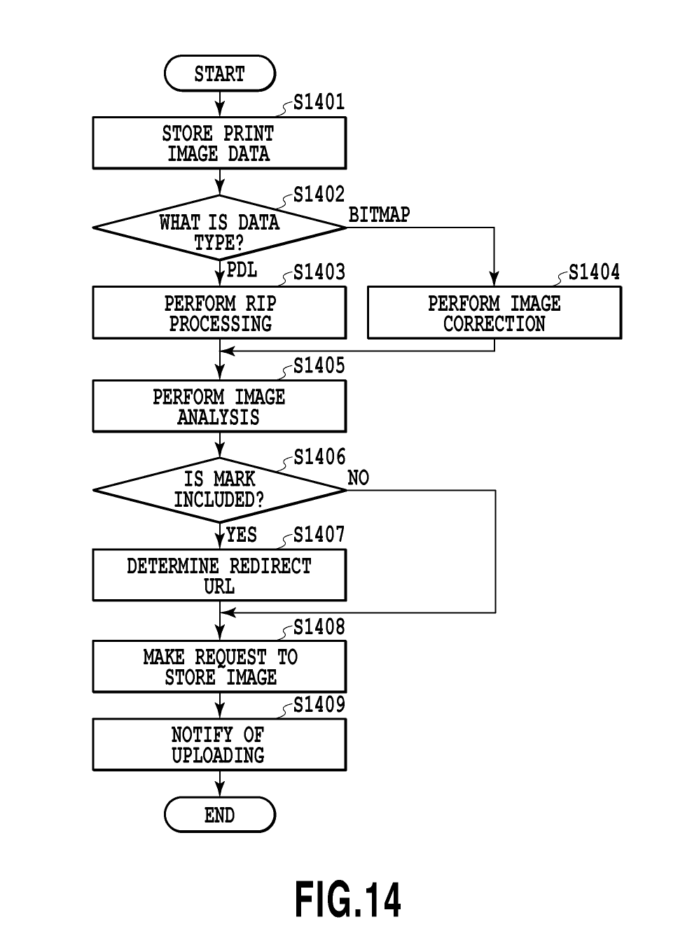

At step 1304, the printing processing application 700 performs uploading processing of print image data. FIG. 14 is a flowchart showing details of the uploading processing of print image data.

At step 1401, the printing processing application 700 stores the print image data related to the received uploading request in the HDD 304 of the cloud service server 131 by the image data management module 701. At this time, to the print image data that is stored, an ID is given by the image data management module 701 for management.

At step 1402, the printing processing application 700 determines the type (file format) of the print image data related to the uploading request by the input data determination module 703. As a result of the determination, in the case where the print image data is PDL data, the processing proceeds to step 1403. On the other hand, in the case where the print image data is bitmap data, such as JPEG, BMP, and TIFF, the processing proceeds to step 1404.

At step 1403, the printing processing application 700 performs processing to interpret PDL data stored in the HDD 304 and to convert the PDL data into a bitmap image (rasterize processing) by the image conversion module 702. The print image data converted into a bitmap image is stored again in the HDD 304 by the image data management module 701.

At step 1404, the printing processing application 700 performs correction processing (filter processing etc.) on the bitmap data stored in the HDD 304 by the image conversion module 702. The print image data having been subjected to the correction processing is stored again in the HDD 304 by the image data management module 701.

At step 1405, the printing processing application 700 checks whether a mark indicating that an image can be added is included in the print image data stored in the HDD 304 and performs processing to analyze (decode) the mark in the case where the mark is included. As described above, the processing such as the above is performed by the image analysis module 704.

At step 1406, the processing in the printing processing application 700 proceeds to step 1407 in the case where a mark is included in the print image data and the decode processing has been performed on the mark. On the other hand, in the case where no mark is included, the processing proceeds to step 1408.

At step 1407, the printing processing application 700 determines a redirect URL by the redirect URL determination module 706. At this time, the determined redirect URL and the uploaded print image data are associated with each other and managed by the image data management module 701.

At step 1408, the printing processing application 700 transmits a request to store (keep) the uploaded print image data to the cloud storage server 132 together with the print image data.

At step 1409, the printing processing application 700 generates a response to the uploading request and transmits the response and at the same time, notifies members within the group registered in advance of the fact of the uploading.

The above is the contents of the uploading processing of the print image data.

Explanation is returned to the flowchart in FIG. 13.

At step 1305, the printing processing application 700 determines whether or not the kind of the request specified at step 1302 is a printing request. A printing request includes information indicative of the print image data for which printing is requested (ID etc. for specifying the print image data). In the case where the request is a printing request, the processing proceeds to step S1306. On the other hand, in the case where the request is not a printing request, the processing proceeds to step 1307.

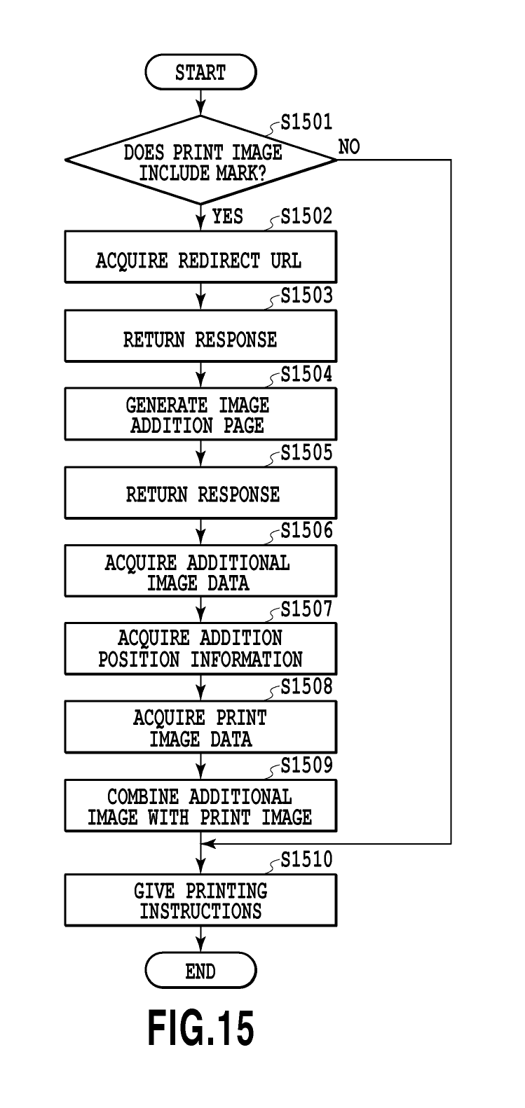

At step 1306, the printing processing application 700 performs processing to print the print image data kept in the cloud storage server 132. FIG. 15 is a flowchart showing details of the processing to print the print image data kept in the cloud storage server 132.

At step 1501, the printing processing application 700 determines whether the print image data related to the received printing request includes a mark indicating that an image can be added by referring to ID information included in the printing request. In the case where the print image data includes a mark, the processing proceeds to step 1502. On the other hand, in the case where the print image data does not include a mark, the processing proceeds to step 1510.

At step 1502, the printing processing application 700 refers to ID information included in the received printing request and acquires information on the redirect URL associated with the print image data of the ID information from the image data management module 701.

At step 1503, the printing processing application 700 generates a response including the acquired redirect URL and transmits the response to the mobile terminal 151, which has transmitted the printing request.

At step 1504, the printing processing application 700 receives a request redirected from the mobile terminal 151 having received the response and generates HTML data of the image addition page described previously.

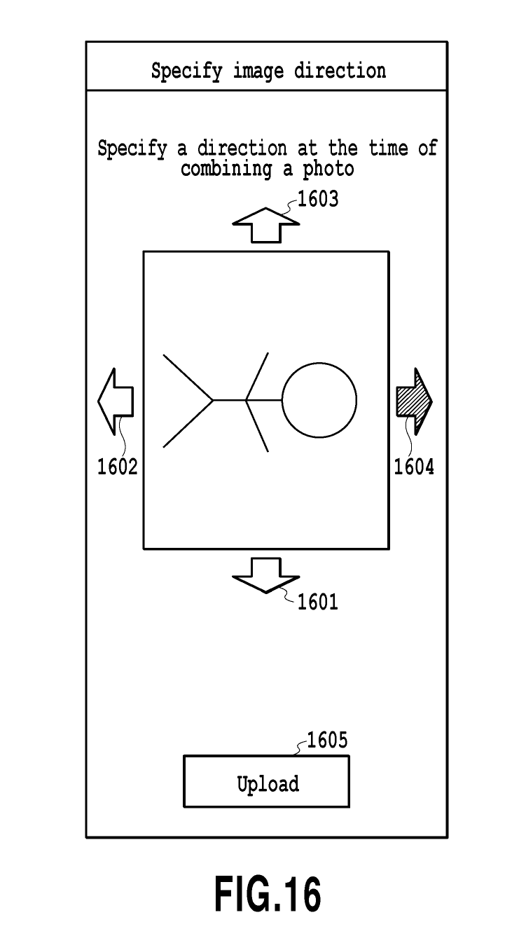

At step 1505, the printing processing application 700 generates a response including the generated HTML data of the image addition page and transmits the response to the mobile terminal 151. A user photographs etc. an additional image via the image addition page and uploads data of the image that a user desires to add to the cloud service server 131. At this time, it may also be possible to transmit information indicative of the direction in which the additional image should be combined together with the additional image data. FIG. 16 is an example of a UI screen on which to specify the direction in which an image is pasted. On the UI screen, there are provided four arrows 1601 to 1604 for specifying the side of a photographed image which should be top at the time of the image being pasted and in this example, the arrow 1604 has been pressed down and the right side (the side near the head of a person) is specified to be the top side at the time of the image being pasted. It is only required for a user to press down an Upload button 1605 after specifying the direction in which an image to be inserted should be pasted by specifying a direction on the UI screen such as this.

At step 1506, the printing processing application 700 receives the data of the additional image from the mobile terminal 151.

At step 1507, the printing processing application 700 acquires the above-described addition position information on the received additional image.

At step 1508, the printing processing application 700 requests and acquires the print image data related to the printing request from the cloud storage server 132.

At step 1509, the printing processing application 700 combines the print image data and the additional image data in accordance with the acquired addition position information (and information on the direction).

At step 1510, the cloud service server 131 transmits a request to print the print image data with which the additional image is combined (combined image data) to the MFP 101. By this, the processing to produce a printout of the received combined image data is performed in the MFP 101.

Explanation is returned to the flowchart in FIG. 13.

At step 1307, the printing processing application 700 determines that an unexpected request has been received and performs error processing. For example, the printing processing application 700 generates a response including the HTTP status code 400 (Bad Request) and returns the response to the browser 601 of the mobile terminal 151.

The above is the processing in the cloud service server 131 in the present embodiment.

According to the present embodiment, in the cloud-type printing service, it is possible to perform printing after easily adding an image photographed etc. by a mobile terminal etc. at the time of printing print image data uploaded to the server.

### Second Embodiment

Next, an aspect is explained as a second embodiment, in which in a cloud service for saving scan data etc. in a server on a network, data of an image photographed etc. by a camera application of a mobile terminal is added to the scan data etc. and then the scan data etc. is saved. For the portions in common to those in the first embodiment, explanation is omitted or simplified and here, different points are explained mainly.

The basic system configuration and the hardware configuration of each device configuring the system are in common to those in the first embodiment. However, the cloud service server 131 in the present embodiment is a server that provides a storage saving service for receiving image data, such as scan data, from an external MFP etc. and keeping the received image data in the cloud storage server 132.

### <Software Configuration of MFP>

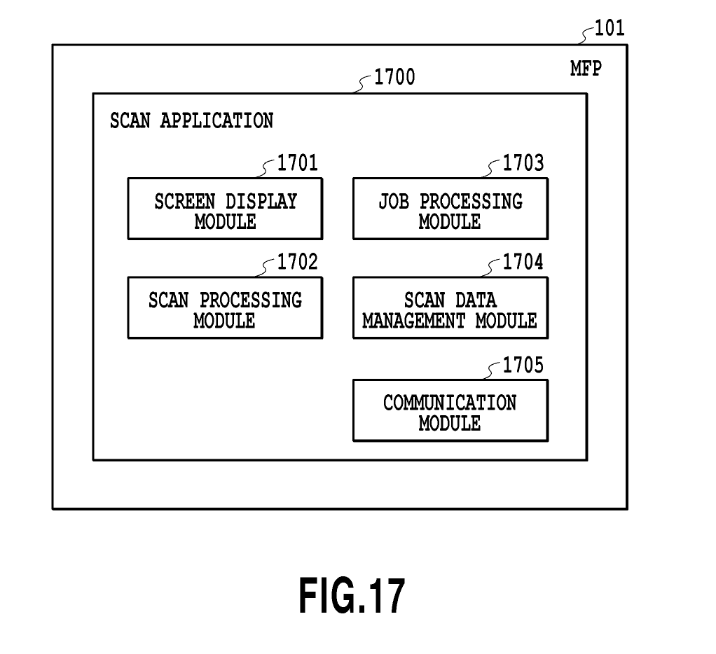

FIG. 17 is a diagram showing an example of a software (scan application for scan processing and its modules) configuration that the MFP 101 includes. The program of the scan application is stored in the HDD 204 and the CPU 201 develops the program onto the RAM 203 and then executes the program.

A scan application 1700 is software for generating scan data by performing scan processing on a paper document set on a document table etc., not shown, and includes each of modules 1701 to 1705 below.

A screen display module 1701 is a software module for displaying various kinds of information about the execution of the scan processing on the operation unit 111.

A scan processing module 1702 is a software module for performing processing to read a paper document by driving the scanner unit 112 via the scanner I/F 217. Image data (scan data) obtained by the scanner unit 112 is stored in the HDD 204.

A job processing module 1703 is a software module for converting image data stored in the HDD 204 into an image format, such as JPEG.

A scan data management module 1704 is a software module for managing the image data converted by the job processing module 1703 as scan data.

A communication module 1705 is a software module for performing communication with the cloud service server 131 via the network I/F 206.

### <Software Configuration of Cloud Service Server>

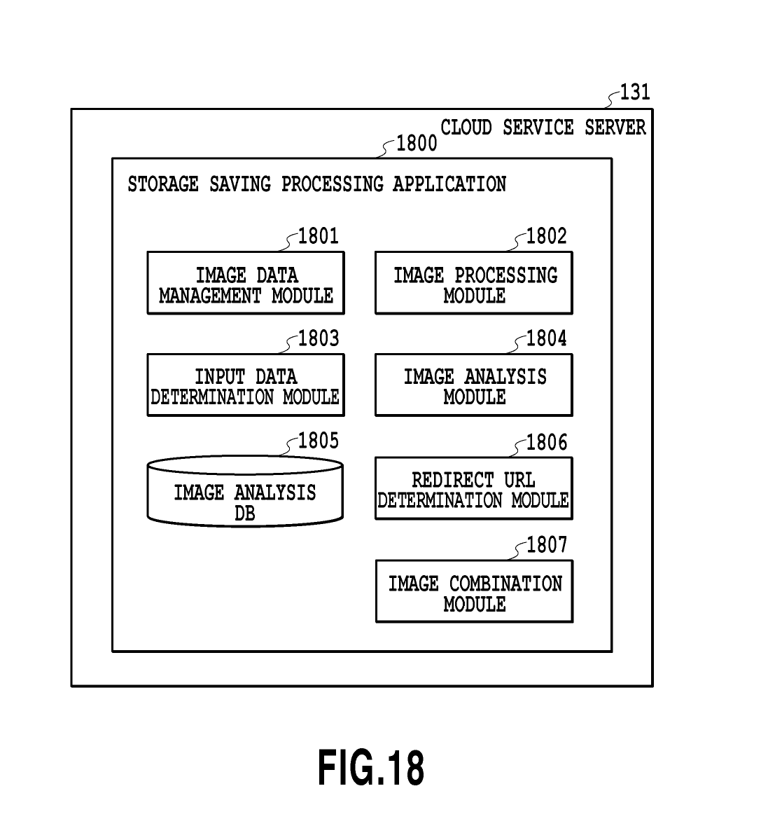

FIG. 18 is a diagram showing an example of a software (storage saving processing application and its modules) configuration that the cloud service server 131 includes. The program of the application is stored in the HDD 304 and the CPU 310 develops the program onto the RAM 302 and then executes the program.

A storage saving processing application 1800 is a Web application for making public the Web services on the cloud service server 131 and performing processing for storage saving.

An image data management module 1801 is a module for managing intermediate data produced in the processes of various kinds of processing on image data that is a target of storage saving (hereinafter, saving-target image data).

An image processing module 1802 is a module for performing necessary image processing on saving-target image data received by the storage saving processing application 1800. For example, in the case of a photo image input from a camera etc., the module performs correction processing, such as trapezoid correction. Further, the module also generates a preview image etc.

An input data determination module 1803 is a module for determining from which device the saving-target image data received by the storage saving processing application 1800 has been input. For example, in the case where saving-target image data is provided in the JPEG image format, it is possible to extract Exif information included in the JPEG and to specify a device having generated the saving-target image data. In this manner, whether the received saving-target image data is scan data read by a scanner or data of a photo image photographed by a camera etc. is determined.

An image analysis module 1804, an image analysis DB 1805, a redirect URL determination module 1806, and an image combination module 1807 correspond to the modules 704, 705, 706, and 707, respectively, in the first embodiment.

### <Processing Sequence>

Next, a flow of the processing from uploading of saving-target image data until the saving-target image data is saved in the storage server is explained. In the following, a case is supposed where by registering the use of the service, a notification is transmitted to a mobile terminal etc. at the time of uploading of saving-target image data (in the present embodiment, scan data) and after an image photographed etc. by a mobile terminal etc. is combined with the saving-target image data, the saving-target image data is saved in the server.

In the present embodiment, a case is explained as an example, where scan data obtained by scanning a paper document by the MFP 101 is uploaded as saving-target image data, but data of a photo image photographed by a device having the camera function, such as, for example, a mobile terminal, may be uploaded as saving-target image data.

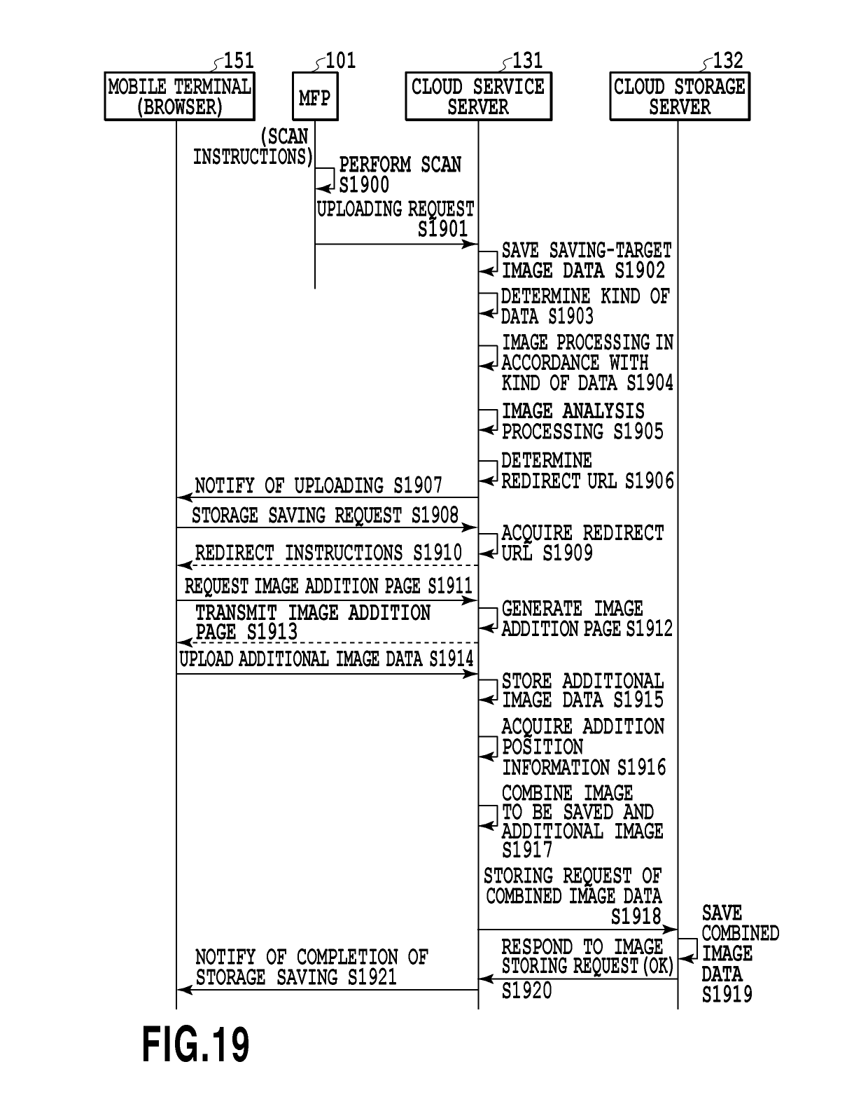

FIG. 19 is a sequence chart showing a flow of the processing from scan processing of a paper document until scan data as saving-target image data is saved in the storage server.

At step 1900, upon receipt of instructions of a user, the MFP 101 performs a scan of a paper document set on a document table etc., not shown, by the scan application 1700. An image signal obtained by the scan is turned into scan data by the job processing module 503 and is stored in the HDD 204 by the scan data management module 504.

At step 1901, upon receipt of instructions of a user via a UI screen, not shown, the MFP 101 transmits a request to upload obtained scan data to the cloud service server 131. The uploading request includes information on the user having given the instructions and scan data as saving-target image data.

At step 1902, the cloud service server 131 (storage saving processing application 1800) stores received saving-target image data in the HDD 304. At this time, each piece of the saving-target image data is given an ID by the image data management module 1801 and then is managed.

At step 1903, the cloud service server 131 (input data determination module 1803) determines the kind of the received image data.

At step 1904, the cloud service server 131 (image processing module 1802) performs image processing (processing, such as trapezoid correction and background removal) in accordance with the kind of the received saving-target image data based on the determination result at step 1903. In the case of the present embodiment, the saving-target image data is scan data, and therefore, image processing, such as background removal, in accordance therewith is performed as a result.

At step 1905, the cloud service server 131 (image analysis module 1804) performs the previously-described analysis processing on the saving-target image data having been subjected to necessary image processing. In other words, whether a mark indicating that an image can be added is included is checked and in the case where a mark is included, the analysis (decode) processing is performed thereon.

In the case where a mark is recognized as the result of the analysis processing at step 1905, the cloud service server 131 (redirect URL determination module 1806) determines the redirect URL at step 1906.

At step 1907, the cloud service server 131 makes a notification to the effect that saving-target image data has been uploaded by a member within the group by referring to mail addresses registered in advance.

At step 1908, in response to the instructions of a user, the mobile terminal 151 transmits a storage saving request of the saving-target image data related to the notification to the cloud service server 131. The storage saving request at this time includes a date, a job ID, etc., in addition to the ID of the saving-target image data, as in the printing request in the first embodiment.

Each piece of the processing at step 1909 to step 1916 corresponds to each piece of the processing at step 911 to step 918 in the first embodiment and they are not different in particular, and therefore, explanation is omitted.

At step 1917, the cloud service server 131 (image combination module 1807) combines the uploaded saving-target image data (here, scan data) and the additional image data in accordance with the addition position information described previously.

At step 1918, the cloud service server 131 transmits a request to store the saving-target image data with which the additional image has been combined (combined image data) to the cloud storage server 132 together with the combined image data.

At step 1919, the cloud storage server 132 stores and saves the received combined image data within the HDD 304.

At step 1920, the cloud storage server 132 returns a response to the effect that the combined image data related to the storage saving request has been saved to the cloud service server 131.

At step 1921, the cloud service server 131 transmits a notification to the effect that storage saving has been completed to the mobile terminal 151.

The above is the flow of the processing from the uploading of saving-target image data until the saving-target image data is saved in the storage server.

In the case where a mark indicating that an image can be added is not recognized as the result of the analysis processing (step 1905), upon receipt of the storage saving request (step 1908), instructions to perform the saving thereof are given immediately to the cloud storage server 132 (step 1918).

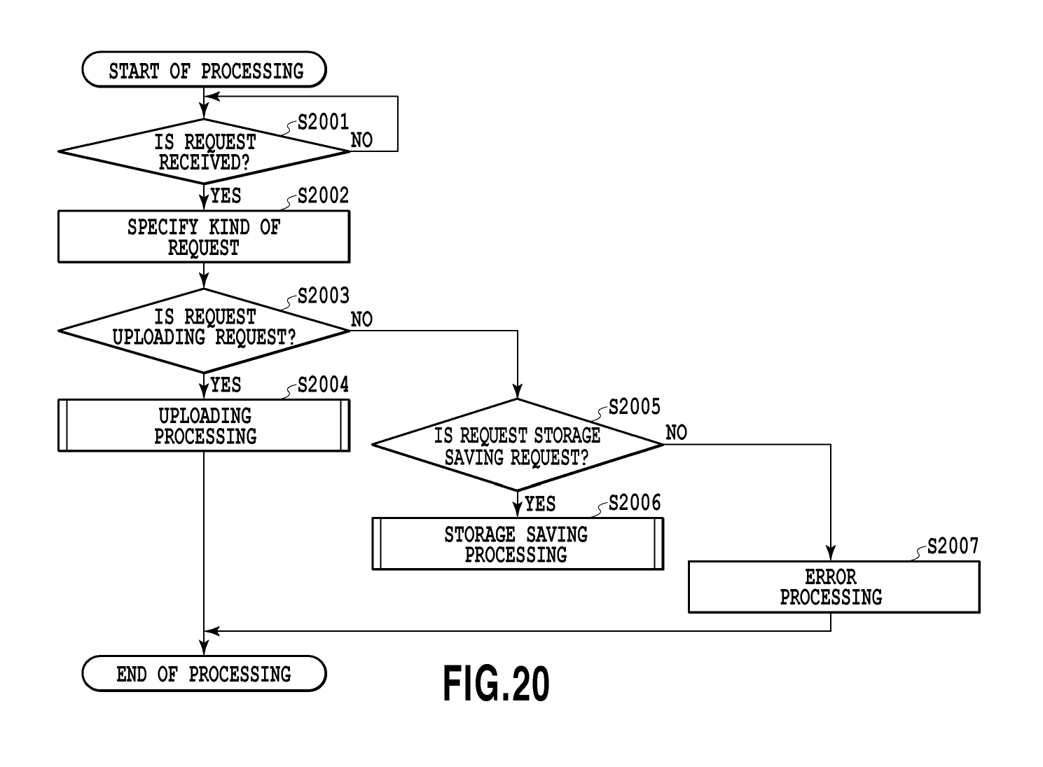

Next, a flow of each piece of the processing is explained by focusing on the processing performed in the cloud service server 131. FIG. 20 is a flowchart showing a flow of the processing in the cloud service server 131 according to the present embodiment.

At step 2001, the storage saving processing application 1800 is in the state of waiting for a request as a Web application. Upon receipt of a request, the processing proceeds to step 2002.

At step 2002, the storage saving processing application 1800 acquires request URL information included in the received request and specifies the kind of the request. In the present embodiment, there are two kinds of requests: an uploading request and a storage saving request.

At step 2003, the storage saving processing application 1800 determines whether or not the kind of the request specified at step 2002 is an uploading request. In the case where the request is an uploading request, the processing proceeds to step 2004. On the other hand, in the case where the request is not an uploading request, the processing proceeds to step 2005.

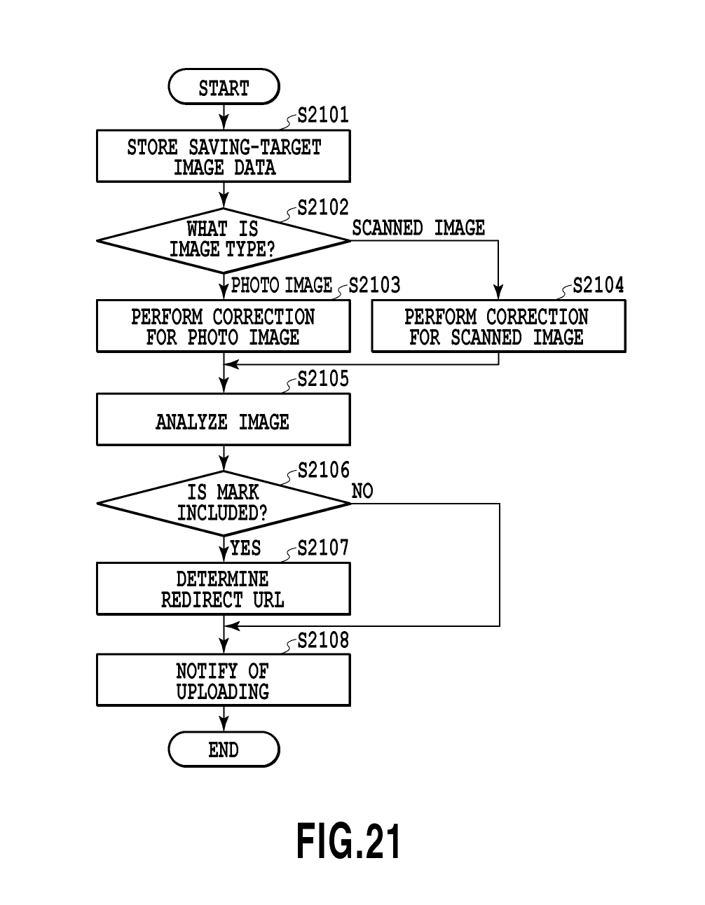

At step 2004, the storage saving processing application 1800 performs uploading processing of the saving-target image data. FIG. 21 is a flowchart showing details of the uploading processing of the saving-target image data.

At step 2101, the storage saving processing application 1800 stores the saving-target image data related to the received uploading request in the HDD 304 of the cloud service server 131 by the image data management module 1801. At this time, the saving-target image data to be stored is given an ID by the image data management module 1801 and then is managed.

At step 2102, the storage saving processing application 1800 determines from which device the uploaded saving-target image data has been input by the input data determination module 1803. In the case where it is determined that the saving-target image data has been input by a device having the photographing function, such as a camera, (data is photo image data) as the result of the determination, the processing proceeds to step 2103. On the other hand, in the case where it is determined that the saving-target image data has been input by a scanner etc. (data is scan data) as the result of the determination, the processing proceeds to step 2104.

At step 2103, the storage saving processing application 1800 performs correction processing in accordance with the photo image data as the uploaded saving-target image data by the image processing module 1802. The saving-target image data having been subjected to the correction processing is stored again in the HDD 304 by the image data management module 1801.

At step 2104, the storage saving processing application 1800 performs correction processing in accordance with the scan data as the uploaded saving-target image data by the image processing module 1802. The saving-target image data having been subjected to the correction processing is stored again in the HDD 304 by the image data management module 1801.

At step 2105, the storage saving processing application 1800 checks whether a mark indicating that an image can be added is included in the uploaded saving-target image data, and in the case where a mark is included, the analysis (decode) processing is performed thereon. As described above, the processing such as the above is performed by the image analysis module 1804.

At step 2106, the processing in the storage saving processing application 1800 proceeds to step 2107 in the case where a mark is included in the saving-target image data and the decode processing has been performed thereon. On the other hand, the processing proceeds to step 2108 in the case where a mark is not included.

At step 2107, the storage saving processing application 1800 determines the redirect URL by the redirect URL determination module 1806. At this time, the determined redirect URL and the uploaded saving-target image data are associated with each other and managed by the image data management module 1801.

At step 2108, the storage saving processing application 1800 generates a response to the uploading request and returns the response and at the same time, notifies the members within the group registered in advance of the fact of the uploading.

The above is the contents of the uploading processing of the saving-target image data.

Explanation is returned to the flowchart in FIG. 20.

At step 2005, the storage saving processing application 1800 determines whether or not the kind of the request specified at step 2002 is a storage saving request. A storage saving request includes information indicative of the saving-target image data for which the request has been made (ID specifying saving-target image data etc.). In the case where the request is a storage saving request, the processing proceeds to step 2006. On the other hand, in the case where the request is not a storage saving request, the processing proceeds to step 2007.

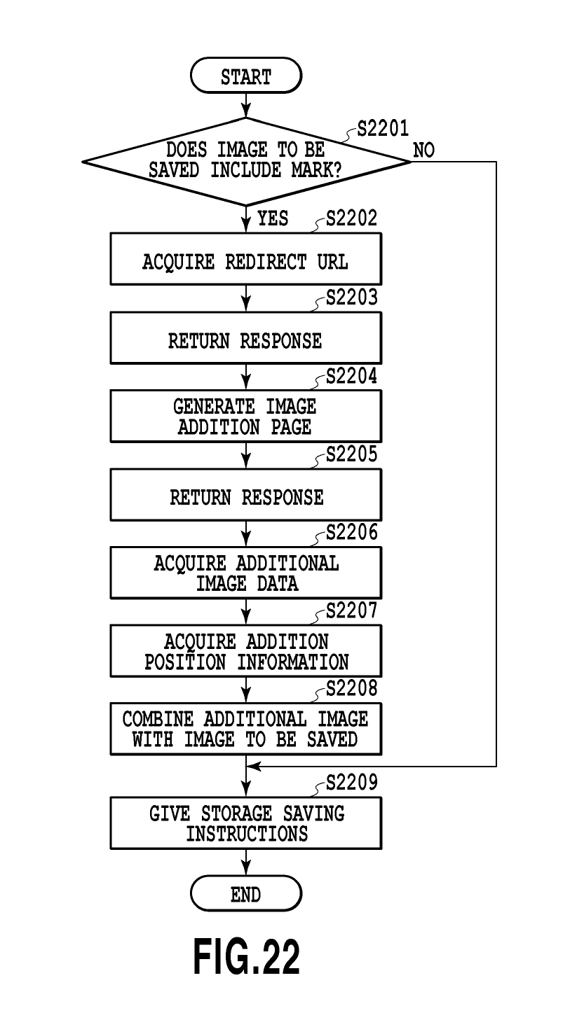

At step 2006, the storage saving processing application 1800 performs processing to save the saving-target image data related to the storage saving request in the cloud storage server 132. FIG. 22 is a flowchart showing details of the processing to save the saving-target image data in the cloud storage server 132.

At step 2201, the storage saving processing application 1800 determines whether the saving-target image data related to the storage saving request includes a mark indicating that an image can be added by referring to ID information included in the storage saving request. In the case where the saving-target image data includes a mark, the processing proceeds to step 2202. On the other hand, in the case where the saving-target image data does not include a mark, the processing proceeds to step 2209.

At step 2202, the storage saving processing application 1800 refers to ID information included in the received storage saving request. Then, the storage saving processing application 1800 acquires information on the redirect URL associated with the saving-target image data corresponding to the ID information from the image data management module 1801.

At step 2203, the storage saving processing application 1800 generates a response including the acquired redirect URL and transmits the response to the mobile terminal 151, which has transmitted the storage saving request.

At step 2204, the storage saving processing application 1800 receives a request redirected from the mobile terminal 151 having received the response and generates HTML data of the image addition page described previously.

At step 2205, the storage saving processing application 1800 generates a response including the generated HTML data of the image addition page and returns the response to the mobile terminal 151. A user photographs etc. an additional image via the image addition page and uploads additional image data to the cloud service server 131.

At step 2206, the storage saving processing application 1800 receives additional image data from the mobile terminal 151. As described in the first embodiment, it may also be possible to receive direction information indicative of the direction in which the additional image should be combined together with the data of the additional image.

At step 2207, the storage saving processing application 1800 acquires addition position information on the received additional image.

At step 2208, the storage saving processing application 1800 reads the saving-target image data and the additional image data from the HDD 304 and combines both pieces of data in accordance with the acquired addition position information (and direction information). The generated combined image data is converted into a file format, such as PDF.

At step 2209, the cloud service server 131 gives instructions to save the combined image data obtained by the combination processing to the cloud storage server 132. Due to this, saving processing of the received combined image data is performed in the cloud storage server 132. It may also be possible to save the combined image data based on saving destination information by transmitting the saving destination information together at the time of uploading the additional image data.

Explanation is returned to the flowchart in FIG. 20.

At step 2007, the storage saving processing application 1800 determines that an unexpected request has been received, and performs error processing.

The above is the processing in the cloud service server 131 in the present embodiment.

As above, according to the present embodiment, it is possible to easily add an image photographed etc. by a mobile terminal etc. to saving-target image data uploaded to the server and save the saving-target image data in a cloud-type storage service.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-242160, filed on Nov. 22, 2013, which is hereby incorporated by reference herein in its entirety.

What is claimed is:

1. An information processing apparatus capable of communicating with an apparatus capable of supplying image data via a network, and for providing a cloud-type printing service, the information processing apparatus comprising:
a unit configured to determine whether a mark indicating that an image can be added is included in a print image;
a prompting unit configured to prompt the apparatus capable of supplying image data to supply data of an additional image in a case where it is determined that the mark is included in the print image;
a combination unit configured to combine the additional image supplied from the apparatus with the print image; and
a unit configured to give instructions to print the combined image generated by the combination to a printing apparatus connected via the network.

2. The information processing apparatus according to claim 1, wherein
the apparatus has a camera, and
data of an image photographed by the camera is supplied as data of the additional image in response to the prompt from the prompting unit.

3. The information processing apparatus according to claim 2, wherein
data of an image photographed by the camera or data of an image selected from images saved in advance is supplied as data of the additional image in response to the prompt of the prompting unit.

4. The information processing apparatus according to claim 1, wherein
the combination unit performs the combination based on information, which is supplied together with the additional image from the apparatus, for specifying a position where the additional image should be combined with the print image.

5. The information processing apparatus according to claim 4, wherein
the combination unit performs the combination further based on information, which is supplied together with the additional image from the apparatus, for specifying a direction in which the additional image should be combined with the print image.

6. An information processing apparatus capable of communicating with an apparatus capable of supplying image data via a network, and for providing a cloud-type storage service, the information processing apparatus comprising:
a unit configured to determine whether a mark indicating that an image can be added is included in an image to be saved;
a unit configured to prompt the apparatus capable of supplying image data to supply data of an additional image in a case where it is determined that the mark is included in the image to be saved;
a combination unit configured to combine the additional image supplied from the apparatus with the image to be saved; and
a unit configured to give instructions to save the combined image generated by the combination to an information processing apparatus connected via the network and for performing data saving.

7. The information processing apparatus according to claim 6, wherein
the apparatus has a camera, and
data of an image photographed by the camera is supplied as data of the additional image in response to the prompt from the prompting unit.

8. The information processing apparatus according to claim 7, wherein
data of an image photographed by the camera or data of an image selected from images saved in advance is supplied as data of the additional image in response to the prompt of the prompting unit.

9. The information processing apparatus according to claim 6, wherein
the combination unit performs the combination based on information, which is supplied together with the additional image from the apparatus, for specifying a position where the additional image should be combined with the print image.

10. The information processing apparatus according to claim 9, wherein
the combination unit performs the combination further based on information, which is supplied together with the additional image from the apparatus, for specifying a direction in which the additional image should be combined with the print image.

11. A system for providing a cloud-type service, the system comprising the information processing apparatus according to claim 1 and at least the apparatus capable of supplying image data.

12. An image data processing method in an information processing apparatus capable of communicating with an apparatus capable of supplying image data via a network, and for providing a cloud-type printing service, the method comprising the steps of:
determining whether a mark indicating that an image can be added is included in a print image;
prompting the apparatus capable of supplying image data to supply data of an additional image in a case where it is determined that the mark is included in the print image;
combining the additional image supplied from the apparatus with the print image; and
giving instructions to print the combined image generated by the combination to a printing apparatus connected via the network.

13. An image data processing method in an information processing apparatus capable of communicating with an apparatus capable of supplying image data via a network and for providing a cloud-type storage service, the method comprising the steps of:
determining whether a mark indicating that an image can be added is included in an image to be saved;
prompting the apparatus capable of supplying image data to supply data of an additional image in a case where it is determined that the mark is included in the image to be saved;
combining the additional image supplied from the apparatus with the image to be saved; and
giving instructions to save the combined image generated by the combination to an information processing apparatus connected via the network and for performing data saving.

14. A non-transitory computer readable storage medium storing a program for causing a computer to perform the method according to claim 12.

15. A non-transitory computer readable storage medium storing a program for causing a computer to perform the method according to claim 13.
